(19) United States
(12) Patent Application Publication
(10) Pub. No.: US 2015/0199542 A1
(43) Pub. Date: Jul. 16, 2015

(54) COMMUNICATION DEVICE AND ANTI-LOSS METHOD

(71) Applicants: Fu Tai Hua Industry (Shenzhen) Co., Ltd., Shenzhen (CN); HON HAI PRECISION INDUSTRY CO., LTD., New Taipei (TW)

(72) Inventor: JIAN-GUO WU, Shenzhen (CN)

(21) Appl. No.: 14/498,487

(22) Filed: Sep. 26, 2014

(30) Foreign Application Priority Data
Jan. 16, 2014 (CN) 2014100196407

(51) Int. Cl. G06F 21/88; G06F 21/31

(52) U.S. Cl. CPC G06F 21/88; G06F 21/31

(57) ABSTRACT

A communication device providing assistance to a user when the communication device is lost or misplaced includes a display panel, a processing module, an image capturing module, and a transmission module. When the display panel displays a locked interface, and the locked interface is not unlocked within a preset time period, the processing module sends a capture image signal to the image capturing module. The image capturing module captures a front image in response and sends the image to a preset email address via the transmission module. The invention also provides a method of providing clues for finding a lost or misplaced communication device.

### CROSS-REFERENCE TO RELATED APPLICATIONS

This application claims priority to Chinese Patent Application No. 201410019640.7 filed on Jan. 16, 2014, in the China Intellectual Property Office, the contents of which are incorporated by reference herein.

### FIELD

The present disclosure relates to property security as applied to communication devices.

### BACKGROUND

Mobile phones are necessary for people to communicate with each other and mobile phones can be lost or misplaced.

### BRIEF DESCRIPTION OF THE DRAWING

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of a communication device according to an exemplary embodiment.

FIG. 2 is a flowchart of a method for finding a lost or misplaced communication device.

### DETAILED DESCRIPTION

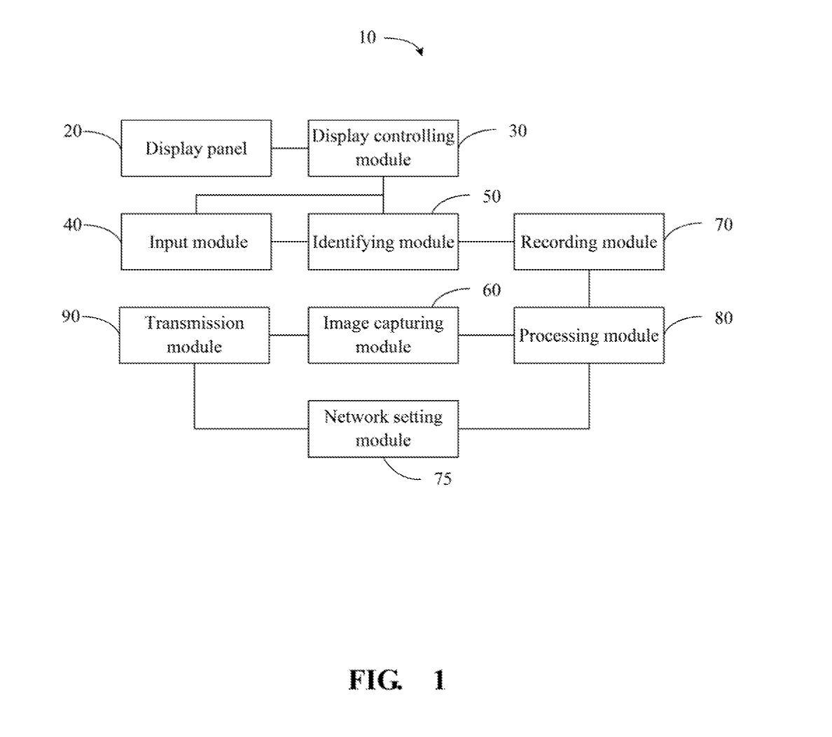

FIG. 1 shows a block diagram of a communication device 10 according to an exemplary embodiment. The communication device 10 includes a display panel 20, a display controlling module 30, an input module 40, an identifying module 50, an image capturing module 60, a recording module 70, a processing module 80, and a transmission module 90.

The display controlling module 30 is configured to control the display panel 20 to display a locked interface in response to an unlocking operation. The unlocking operation can be pressing or pushing a power button or a home button. The input module 40 is configured to input and record a password of a user. The input module 40 can be a touch keyboard displayed on the display panel 20.

The identifying module 50 is configured to identify whether a password which has been input accords with a preset password. The display controlling module 30 is further configured to control the display panel 20 to display an unlocked interface when the input password corresponds with the preset password.

The recording module 70 is configured to record how many times a incorrect password is input in a first preset period time, starting from the time that the locked interface is displayed. If the incorrect password is input consistently t, the user is seen as an illegal user. The processing module 80 is configured to send a capture image signal to the image capturing module 60 when the number of times a incorrect password is input during the first preset period time reaches a preset value.

The image capturing module 60 is configured to capture an image of the scene in front of the display panel 20 in response to the capture image signal. The illegal user can be facing the display panel 20, thus the image can capture the illegal user. The image capturing module 60 can be a front-facing camera fixed to a shell of the communication device 10. In at least one embodiment, the image capturing module 60 continuously captures images of the scene in front of the display panel 20 in response to the capture image signal in a second preset period time.

The transmission module 90 can be configured to transmit the image(s) to a preset email address via the internet. The preset email address relates to a legal user of the communication device 10. When the communication device 10 is lost by the legal user, the legal user can open the email address to view the image(s) and obtain clues for finding the communication device 10.

In at least one embodiment, the communication device 10 further includes a network setting module 75. The network setting module 75 is configured to automatically open an access to internet in response to the capture image signal, to enable the transmission module 90 to transmit the image(s) to the preset email address via the network.

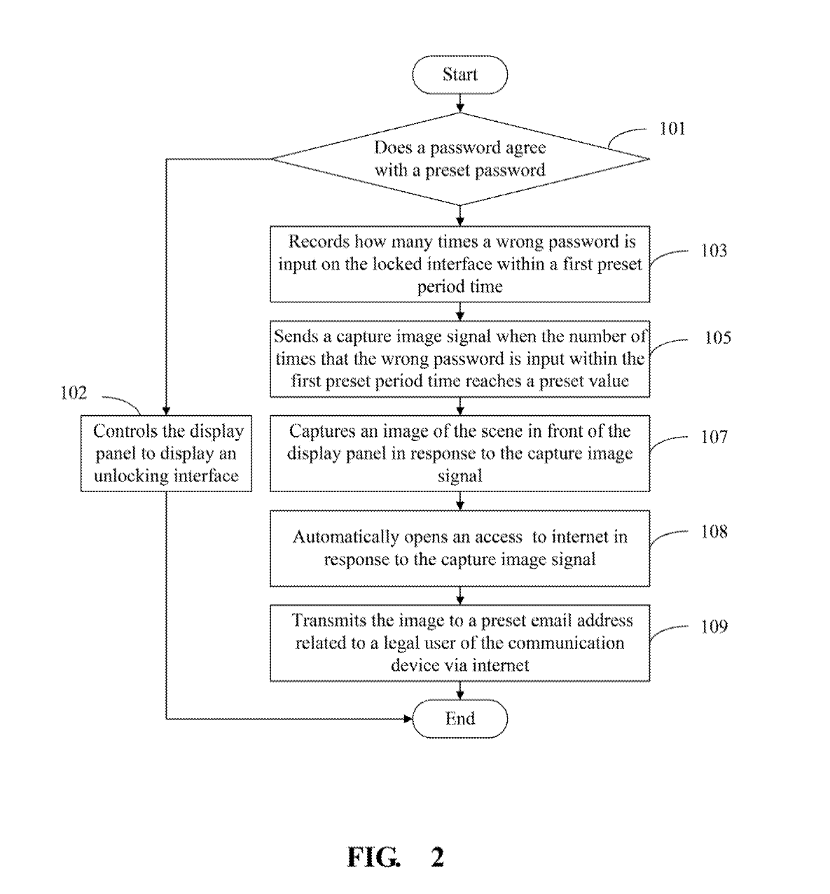

FIG. 2 illustrates a flowchart of a method of providing clues for finding the lost or misplaced communication device 10. The method includes following blocks.

In block 101, the identifying module 50 identifies whether a password input on a locked interface displayed on the display panel 20 of the communication device 10 agrees with a preset password. If the input password is correct, the method proceeds to block 102, otherwise the method proceeds to block 103.

In block 102, the display controlling module 30 controls the display panel 20 to display an unlocking interface.

In block 103, the recording module 70 records how many times a incorrect password is input on the locked interface within a first preset period time.

In block 105, the processing module 80 sends a capture image signal when the number of times that the incorrect password is input within the first preset period time reaches a preset value.

In block 107, the image capturing module 60 captures an image of the scene in front of the display panel 20 in response to the capture image signal. The image capturing module 60 can be a front-facing camera fixed to a shell of the communication device 10. In at least one embodiment, the image capturing module 60 continuously captures images of the scene in front of the display panel 20 in response to the capture image signal within a second preset period time.

In block 108, the network setting module 75 automatically opens an access to internet in response to the capture image signal.

In block 109, the transmission module 90 transmits the image to a preset email address via internet. The preset email address is related to a legal user of the communication device 10.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A communication device comprising:
a display panel configured to display a locked interface;
a processing module configured to send a capture image signal when the locked interface is not unlocked in a first preset period time;
an image capturing module configured to capture an image of the scene in front of the display panel in response to the captured image signal; and
a transmission module configured to transmit the image to a preset email address.

2. The communication device as claimed in claim 1, further comprising a recording module (70) configured to record how many times a incorrect password is input on the display panel in the first preset period time, and the processing module sending the capture image signal when the number of times reaches a preset value.

3. The communication device as claimed in claim 2, further comprising an input module (40) configured to input and record a password of a user.

4. The communication device as claimed in claim 2, wherein the preset value is three.

5. The communication device as claimed in claim 3, wherein the input module is a touch keyboard displayed on the display panel.

6. The communication device as claimed in claim 3, further comprises an identifying module configured to identify whether a password which has been input accords with a preset password and a display controlling module configured to control the display panel to display an unlocked interface when the password agrees with the preset password.

7. The communication device as claimed in claim 1, further comprising a display controlling module configured to control the display panel display the locked interface in response to an unlocking operation.

8. The communication device as claimed in claim 7, wherein the unlocking operation is a press on a power button.

9. The communication device as claimed in claim 7, wherein the unlocking operation is a press on a home button.

10. The communication device as claimed in claim 1, wherein the image capturing module continuously captures images of the scene in front of the display panel in response to the capture image signal.

11. The communication device as claimed in claim 1, wherein the plurality of images are captured in a second preset period time.

12. The communication device as claimed in claim 1, wherein the image capturing module is a front-facing camera fixed to the communication device.

13. The communication device as claimed in claim 1, further comprises a network setting module, the network setting module is configure to automatically open an access to internet in response to the capture image signal.

14. A method of providing clues for finding a lost communication device comprising:
sending a captured image signal when a locked interface displayed on a display panel of the communication device is not unlocked in a first preset period time;
capturing at least one image of the scene in front of the display panel in response to the captured image signal; and
transmitting the images to a preset email address via internet.

15. The method of providing clues for finding a lost communication device as claimed in claim 14, further comprising:
automatically opening an access to internet in response to the capture image signal.

16. The method of providing clues for finding a communication device as claimed in claim 14, wherein the at least one image is captured by a front-facing camera fixed to the communication device.

17. The method of providing clues for finding a communication device as claimed in claim 14, further comprising:
recording how many times a incorrect password is input on the locked interface in the first preset period time; and
sending the captured image signal when the number of times reaches a preset value.

18. The method of providing clues for finding a communication device as claimed in claim 14, further comprising:
identifying whether a password has been input on the locked interface agrees with a preset password; and
controlling the display panel to display an unlocked interface when the input password agrees with the preset password.

19. A method for assisting in recovery of a stolen communication device comprising:
initializing a timer when a locked interface is displayed on a communication device;
determining whether the locked interface is unlocked within a preset period of time from when the timer is initialized;
sending a capture image signal to an image capturing module if the locked interface is not unlocked within the preset period of time;
capturing at least one image from a front side of the communication device; and
transmitting the at least one captured image wirelessly to a preset receiving site.

20. The method of providing clues for finding a communication device as claimed in claim 14, further comprising:
automatically opening an access to internet in response to the capture image signal.
